(19) United States
(12) Patent Application Publication
(10) Pub. No.: US 2026/0049791 A1
(43) Pub. Date: Feb. 19, 2026

(54) Holster State Detection

(71) Applicant: Axon Enterprise, Inc., Scottsdale, AZ (US)

(72) Inventors: Gerzain Mata, Scottsdale, AZ (US); Christopher P. Tucker, Peoria, AZ (US)

(73) Assignee: Axon Enterprise, Inc., Scottsdale, AZ (US)

(21) Appl. No.: 19/304,336

(22) Filed: Aug. 19, 2025

Related U.S. Application Data
(60) Provisional application No. 63/684,826, filed on Aug. 19, 2024.

(51) Int. Cl. F41C 33/02; G01D 5/30

(52) U.S. Cl. CPC F41C 33/029; G01D 5/30

(57) ABSTRACT

A state management system manages a device state associated with a simulation device The state management system may comprise a first set of sensors associated with a leading edge of the simulation device and a second set of sensors associated with a trailing edge of the simulation device. A control circuit of the state management system may determine a first optical information delta associated with the leading edge and a second optical information delta associated with the trailing edge. The control circuit may determine the device state based on the first optical information delta and the second optical information delta, a device state of the simulation device. The device state may be provided to a simulation environment associated with the simulation device.

### CROSS-REFERENCE TO RELATED APPLICATIONS

This application claims the benefit of U.S. Provisional Patent Application 63/684,826 filed Aug. 19, 2024, which is incorporated by reference herein in entirety.

### FIELD OF THE INVENTION

Embodiments of the present disclosure relate to detecting a holster state for a projectile launcher and/or a handle.

### BRIEF DESCRIPTION OF THE DRAWINGS

FIG. 1A is a perspective view of a projectile launcher, in accordance with various embodiments;

FIG. 1B is a perspective view of a handle, in accordance with various embodiments;

FIG. 2 is a schematic view of a projectile launcher and/or a handle, in accordance with various embodiments;

FIG. 3 is a perspective view of a sensor circuit, in accordance with various embodiments;

FIG. 4A is a perspective view of a handle in association with a holster, in accordance with various embodiments;

FIG. 4B is a perspective view of a handle being associated with a holster, in accordance with various embodiments;

FIG. 5 is a schematic view of a state management operation, in accordance with various embodiments.

### DETAILED DESCRIPTION

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected, or the like may include permanent, removable, temporary, partial, full, and/or any other possible attachment option. Surface shading lines may be used throughout the figures to denote different parts but not necessarily to denote the same or different materials.

Systems, methods, and apparatuses may be used to interfere with, prevent, and/or otherwise disincentivize escalation and/or further interaction during an event. For example, a projectile launcher may be utilized to deploy a deterrent and/or other substance to a human or animal target that disincentivizes further interaction. Additionally, the projectile launcher may be utilized to deploy an identifying substance and/or device to a human or animal target that enables the human or animal target to be identified at a different location and/or a later time removed from the event. The deterrent, identifying substance, and/or other substances may be referred to as a projectile payload.

Systems, methods, and apparatuses may be used to simulate a projectile launcher in a virtual reality (VR) and/or augmented reality (AR) environment. For example, a handle may be configured to simulate, for a user and/or a simulation environment (VR, AR, etc.), a projectile launcher, provide a bearing (e.g., alignment of the handle relative to one or more sensors, a target, a user, etc.), and/or provide a device state. Additionally, the handle may be utilized to generate one or more device outputs that indicate a simulated deployment, activation, and/or other indication. From one or more indications provided by the handle, the simulation environment may display a representation of the projectile launcher, a simulated deployment and interaction of the projectile launcher with a target, and/or other functionality of the projectile launcher within the simulation environment.

A magazine may be a housing and/or structural component that receives one or more projectiles and/or cartridges. The magazine may be configured to receive and/or secure the one or more projectiles (and/or cartridges) within one or more firing tubes. Alternatively, or in addition, the magazine may be configured to enable interaction of the projectile launcher with the simulation environment. Additionally, the magazine may be configured to fit within and/or couple with a handle of a projectile launcher. In some embodiments, each projectile may be directly received in a magazine. For example, the magazine may receive a respective projectile within the one or more firing tubes prior to deployment. After a projectile is deployed, another projectile may be inserted in the magazine to permit launch of another projectile. Projectiles may be inserted within the magazine while the magazine is associated with the handle or when the magazine is unassociated with the handle. Alternately or additionally, the magazine may receive one or more cartridges that each include one or more projectiles. Similar to the respective projectile above, the magazine may receive a respective cartridge within the one or more firing tubes prior to deployment. In some additional embodiments, and based at least on the magazine enabling interaction of the projectile launcher with the simulation environment, the magazine may simulate one or more projectiles that would be received in a deployment magazine (e.g., the magazine configured to deploy one or more projectiles to a target). In addition to providing the bearing of the projectile launcher, the magazine may provide one or more indications of simulated projectile deployment to the simulation environment.

In various embodiments, a magazine may include and/or simulate two or more projectiles (e.g., a cartridge containing two or more projectiles, two or more projectiles are launched directly from two or more firing tubes of the magazine, etc.) that are launched at the same time. In various embodiments, a magazine may include and/or simulate two or more projectiles that may each be launched individually at separate times. In various embodiments, a magazine may include and/or simulate a single projectile configured to be launched from the magazine. Launching the projectiles may be referred to as activating (e.g., firing) a magazine and/or a bay of the handle. The magazine may be configured to provide an indication of launching and/or activating associated with the projectile launcher to the simulation environment. After use (e.g., activation, firing), a magazine may be removed from the bay and replaced with an unused (e.g., not fired, not activated) and/or alternative (e.g., replacing a simulation magazine with a projectile deployment magazine) magazine.

In various embodiments, a projectile launcher may include a handle and one or more magazines (e.g., deployment units, etc.). The handle may include one or more bays for receiving the magazine(s). Each magazine may be removably positioned in (e.g., inserted into, coupled to, etc.) a bay. Each magazine may releasably electrically, electronically, and/or mechanically couple to a bay. A deployment of the projectile launcher may launch one or more projectiles from the magazine toward a target to remotely deliver a projectile payload. Alternatively, or in addition, a deployment of the projectile launcher may cause the magazine to provide one or more indications to the simulation environment.

Systems, methods, and/or apparatuses may be utilized to provide a variety of data tracking, collecting, recording, communicating, and/or managing features. Generally, electronic devices are configured to provide a set of data management features for various individuals. The term electronic device, as used herein, may refer to a physical apparatus or system that incorporates various electronic components and utilizes the electronic components to perform various functions. The various functions may be performed via manipulation of electrical signals and/or circuits. Alternatively, or in addition, the various functions may be performed by one or more analog components configured to accomplish the various functions. The electronic device(s) may encompass a wide range of devices, including but not limited to consumer electronics, communication devices, computing devices, body-worn cameras, signaling devices, monitoring devices, CEWs, medical devices, or any other device that relies on electronic circuitry for operation.

Generally, electronic devices may comprise one or more electronic circuits or subsystems that enable the processing, transmission, storage, or conversion of electronic signals. These circuits may include integrated circuits, discrete components, microprocessors, microcontrollers, digital logic circuits, analog circuits, or a combination thereof. Additionally, the electronic device(s) may feature input interfaces, such as buttons, keyboards, touchscreens, sensors, or any other mechanism that allows users to provide input or interact with the electronic device(s) and/or features of the electronic device(s). Similarly, the electronic device(s) may also include output interfaces, such as displays, speakers, actuators, or other mechanisms that present information, generate responses, and/or transmit signals to users and/or external systems. Further, the electronic device(s) may include power supplies, power sources, and/or other power modules that provide the electrical power during operation. Power modules may include batteries, power adapters, capacitors, or any other means of supplying electrical energy.

In various embodiments, an electronic circuit of the electronic device may be configured as a processing circuit that comprises any circuitry and/or electrical/electronic subsystem for performing a function of the electronic device. A processing circuit may include circuitry that performs (e.g., executes) a stored program. A processing circuit may include a digital signal processor, a microcontroller, a microprocessor, an application specific integrated circuit, a programmable logic device, logic circuitry, state machines, MEMS devices, signal conditioning circuitry, communication circuitry, a conventional computer, a conventional radio, a network appliance, data busses, address busses, and/or a combination thereof in any quantity suitable for performing a function and/or executing one or more stored programs.

A processing circuit may further include conventional passive electronic devices (e.g., resistors, capacitors, inductors) and/or active electronic devices (op amps, comparators, analog-to-digital converters, digital-to-analog converters, programmable logic, transistors). A processing circuit may include conventional data buses, output ports, input ports, timers, memory, and arithmetic units.

A processing circuit may provide and/or receive electrical signals whether digital and/or analog in form. A processing circuit may provide and/or receive digital information via a conventional bus using any conventional protocol. A processing circuit may receive information, manipulate the received information, and provide the manipulated information. A processing circuit may store information and retrieve stored information. Information received, stored, and/or manipulated by the processing circuit may be used to perform a function and/or to perform a stored program.

A processing circuit may have a low power state in which only a portion of its circuits operate and/or it performs only certain function. A processing circuit may be switched (e.g., awoken) from a low power state to a higher power state in which more or all of its circuits operate, it performs additional certain functions, and/or all of its functions.

A processing circuit may control the operation and/or function of other circuits and/or components of a system. A processing circuit may receive status information regarding the operation of other components, perform calculations with respect to the status information, and provide commands (e.g., instructions) to one or more other components for the component to start operation, continue operation, alter operation, suspend operation, or cease operation. Commands and/or status may be communicated between a processing circuit and other circuits and/or components via any type of bus including any type of conventional data/address bus.

In various embodiments, an electronic circuit of the electronic device may be configured as a communication circuit that transmits and/or receives information (e.g., data). A communication circuit may transmit and/or receive (e.g., communicate) information via a wired and/or wireless communication link. A communication circuit may communicate using wireless (e.g., radio, light, sound, vibrations) and/or wired (e.g., electrical, optical) mediums. A communication circuit may communicate using any wireless (e.g., Bluetooth, Zigbee, Wireless Access Protocol (“WAP”), WiFi, Near Field Communication (“NFC”), Infrared Data Association (“IrDA”), Long Term Evolution (“LTE”), Bluetooth Low Energy (“BLE”), EDGE, Evolution-Data Optimized (“EV-DO”), BodyLAN, ANT+) and/or wired (e.g., USB, RS-232, Firewire, Ethernet) communication protocols.

A communication circuit may receive information from a processing circuit for transmission. A communication circuit may provide received information to a processing circuit. A communication circuit in one device (e.g., body worn camera, vehicle, hub, etc.) may communicate with a communication circuit in another device. Communications between two devices may permit the two devices to cooperate in performing a function of either device. A communication circuit may enable intermittent, continuous, seamless, responsive, periodic, aperiodic, and/or other data transfer methodologies to provide access to captured recordings.

Electronic devices may incorporate memory components, such as volatile or non-volatile memory devices, for storing data, instructions, firmware, or software programs. These memory components may comprise any hardware, software, and/or database component capable of storing and maintaining data via temporary and/or persistent storage. For example, a memory unit may comprise any suitable non-transitory memory known in the art, such as, an internal memory (e.g., random access memory (RAM), read-only memory (ROM), solid state drive (SSD), etc.), removable memory (e.g., an SD card, an XD card, a CompactFlash card, etc.), or the like. It should be understood that the term electronic device may reference various forms and configurations, including standalone devices, integrated systems, embedded systems, wearable devices, portable devices, or any other apparatus that utilizes electronic circuitry to perform its intended functions. Accordingly, various embodiments of electronic devices may include integration of electronic components and technologies that provide capabilities for data processing, information exchange, and/or other desired functionalities.

A communication network may be configured to provide transmission and/or reception capabilities for managing information via wired and/or wireless communication paths for communication circuit(s) associated with various electronic devices. A communication circuit may be configured as a network interface that enables a system or an electronic device to communicate with other devices and/or systems over the communication network. The network interface may enable processes performed by processing circuits, logic embedded in hardware, software instructions executable by the processing circuit(s), or any combination thereof to interact with one or more electronic devices via the communication network. The functions performed by a network interface, whether using hardware or software executed by a processor, may be referred to as services. A device may request the services of a communication interface to communicate with an electronic device. A network may include one or more network technologies (e.g., internet, local area network (“LAN”), wide area network (“WAN”), metropolitan area network (“MAN”)).

In various embodiments, the electronic device(s) may comprise a communication interface, a communications component, a communication circuit, and/or other communication units. A communication unit as described herein may comprise any suitable hardware and/or software components capable of enabling the transmission and/or reception of data. A communications unit may enable electronic communications between devices and systems. A communications unit may enable communications over the communication network. Examples of a communications unit may include a modem, a network interface (such as an Ethernet card), a communications port, etc. Data may be transferred via a communications unit in the form of signals which may be electronic, electromagnetic, optical, or other signals capable of being transmitted or received by a communications unit. A communications unit may be configured to communicate via any wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZigBee® protocol maintained by the ZigBee alliance), a cellular protocol, an infrared protocol, an optical protocol, or any other protocol capable of transmitting information via a wired or wireless connection.

Electronic communications between the systems and devices may be unsecure. The communication network may be unsecure. Electronic communications disclosed herein may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

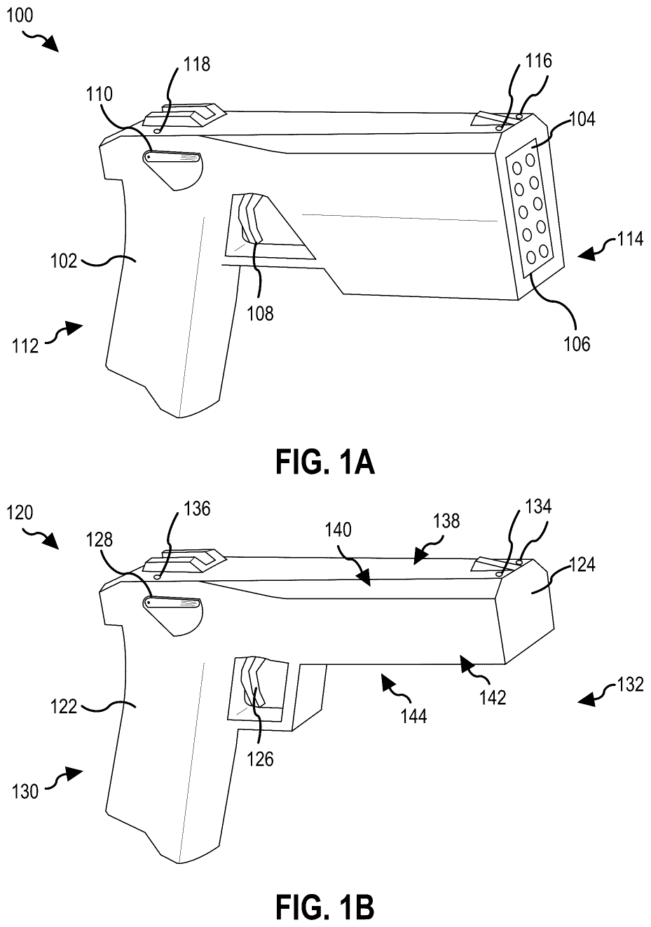

In various embodiments, and with reference to FIG. 1A, a projectile launcher 100 is disclosed. Projectile launcher 100 may be similar to, or have similar aspects and/or components with, any projectile launcher and/or handle discussed herein. Projectile launcher 100 may comprise a housing 102 and a magazine 104. The housing 102 of projectile launcher 100 may further comprise a magazine receiver 106, a trigger 108, a control interface 110, a handle end 112, and a deployment end 114. It should be further noted that any of the one or more components of projectile launcher 100 may be located in any suitable position within, or external to, housing 102.

Housing 102 may be configured to house various components of projectile launcher 100 that are configured to enable activation of magazine 104, provide an electrical current to magazine 104, and otherwise enable interactions between projectile launcher 100 and a simulation environment, as discussed further herein. Although depicted as a firearm in FIG. 1, housing 102 may comprise any suitable shape and/or size. Housing 102 may comprise a handle end 112 opposite a deployment end 114. A deployment end 114 may be configured, sized, and shaped to receive one or more magazines 104 and/or one or more types of magazine via a magazine receiver 106. A handle end 112 may be sized and shaped to be held in a hand of a user. For example, a handle end 112 may be shaped as a handle to enable hand-operation of projectile launcher 100 by the user. In various embodiments, a handle end 112 may also comprise contours shaped to fit the hand of a user, for example, an ergonomic grip. A handle end 112 may include a surface coating, such as, for example, a non-slip surface, a grip pad, a rubber texture, and/or the like. As a further example, a handle end 112 may be wrapped in leather, a colored print, and/or any other suitable material, as desired.

In various embodiments, housing 102 may comprise various mechanical, electronic, and/or electrical components configured to aid in performing the functions and/or simulating the functions of projectile launcher 100. For example, housing 102 may comprise one or more triggers 108, control interfaces 110, processing circuits 202, user interfaces 204, power supplies 206, and/or signal generators 208. Housing 102 may include a guard (e.g., trigger guard). A guard may define an opening formed in housing 102. A guard may be located on a center region of housing 102 (e.g., as depicted in FIG. 1), and/or in any other suitable location on housing 102. Trigger 108 may be disposed within a guard. A guard may be configured to protect trigger 108 from unintentional physical contact (e.g., an unintentional activation of trigger 108). A guard may partially and/or fully surround trigger 108 within housing 102.

Magazine 104 may comprise and/or be associated with one or more propulsion modules and/or one or more projectiles when configured to be used in the field. Additionally, magazine 104 may be configured to simulate one or more propulsion modules and/or one or more projectiles being deployed from projectile launcher 100 for a simulation environment.

In various embodiments, a magazine receiver 106 of housing 102 may be configured to receive and/or couple with one or more magazine 104. Magazine receiver 106 may be configured as and/or include a channel that secures one or more magazine 104 within and/or to the magazine receiver 106. Magazine receiver 106 may be configured to receive at least a portion of magazine 104 to passively (i.e., one or more static structures that secure magazine 104) and/or actively (i.e., one or more dynamic structures that secure magazine 104 by switching from a first state to a second state) secure magazine 104 to housing 102. For example, magazine receiver 106 may be shaped to comprise an opening in deployment end 114 of housing 102 that permits insertion of magazine 104 within magazine receiver 106. Alternatively, or in addition, magazine receiver 106 may comprise one or more flanges, rails, ridges, or raised components that guide and/or secure a portion of magazine 104 within magazine receiver 106. In further examples, magazine receiver may include one or more components that engage magazine 104 based at least in part on magazine 104 being inserted, wherein the one or more components actively secure magazine 104 in response to the insertion. Generally, magazine receiver 106 may comprise one or more mechanical features configured to removably couple one or more magazine 104 within the magazine receiver 106 and in association with projectile launcher 100. The magazine receiver 106 may be configured to receive a single magazine, two magazines, three magazines, nine magazines, or any other number of magazines.

In various embodiments, a magazine receiver 106 of housing 102 may be configured as a bay that receives one or more magazine 104. The bay may comprise an opening at an end of housing 102 sized and shaped to receive one or more magazine 104. The bay may include one or more mechanical features configured to removably couple one or more magazine 104 within the bay. The bay of housing 102 may be configured to receive a single magazine, two magazines, three magazines, nine magazines, or any other number of magazines.

In various embodiments, magazine 104 may comprise a magazine interface that is configured to couple with a housing interface associated with housing 102. Magazine interface and housing interface may be configured to communicate signals, indicators, electrical currents, propellants, and information between magazine 104 and housing 102. For example, inserting magazine 104 into magazine receiver 106 may enable launching of one or more projectiles P by processing circuit 202. Alternatively, or in addition, inserting magazine 104 into magazine receiver 106 may enable one or more signals, indicators, electrical currents, information packets, and/or other indications generated by projectile launcher 100 to be relayed to the simulation environment. Additionally, magazine interface and housing interface may comprise one or more devices, sockets, plugs, connectors, nozzles, and other coupling components that enable the communication of signals, substances, and/or information.

In various embodiments, magazine 104 may comprise a plurality of magazine interfaces and a plurality of housing interfaces associated with housing 102. Individual magazine interfaces and individual housing interfaces may be configured to communicate at least one of signals, electrical currents, propellants, and information between magazine 104 and housing 102. For example, inserting magazine 104 into magazine receiver 106 may enable launching one or more projectiles by processing circuit 202. Alternatively, or in addition, inserting magazine 104 into magazine receiver 106 may enable one or more signals, indicators, electrical currents, information packets, and/or other indications generated by projectile launcher 100 to be received via individual magazine interfaces and relayed to the simulation environment. The plurality of magazine interfaces and the plurality of housing interfaces may couple when magazine 104 is inserted into housing 102, forming one or more communication between magazine 104 and a control circuit of the projectile launcher 100.

In various embodiments, trigger 108 (e.g., projectile launcher trigger, handle trigger, etc.) may be coupled to an outer surface of housing 102, and may be configured to move, slide, rotate, or otherwise become physically depressed or moved upon application of physical contact. For example, trigger 108 may be actuated by physical contact applied to trigger 108 from within a guard. Trigger 108 may comprise a mechanical or electromechanical switch, button, trigger, or the like. For example, trigger 108 may comprise a switch, a pushbutton, and/or any other suitable type of trigger. Trigger 108 may be mechanically and/or electronically coupled to processing circuit 202. In response to trigger 108 being activated (e.g., depressed, pushed, etc. by the user), a processing circuit of projectile launcher 100 may enable deployment of (or cause deployment of) one or more magazine 104 from projectile launcher 100. Additionally, activation of trigger 108 may cause the processing circuit to transmit one or more indications to magazine 104 that are relayed to the simulation environment by magazine 104 and/or a communication interface associated with projectile launcher 100.

In various embodiments, control interface 110 (e.g., projectile launcher control interface, handle control interface, etc.) of projectile launcher 100 may comprise, or be similar to, any control interface disclosed herein. In various embodiments, control interface 110 may be configured to control selection of firing modes in projectile launcher 100. Controlling selection of firing modes in projectile launcher 100 may include disabling firing of projectile launcher 100 (e.g., a safety mode, etc.), enabling firing of projectile launcher 100 (e.g., an active mode, a firing mode, an escalation mode, etc.), controlling deployment of magazine 104, and/or similar operations, as discussed further herein. In various embodiments, control interface 110 may also be configured to perform (or cause performance of) one or more operations that do not include the selection of firing modes. For example, control interface 110 may be configured to enable the selection of operating modes of projectile launcher 100, selection of options within an operating mode of projectile launcher 100, or similar selection or scrolling operations, as discussed further herein.

Control interface 110 may be located in any suitable location on or in housing 102. For example, control interface 110 may be coupled to an outer surface of housing 102. Control interface 110 may be coupled to an outer surface of housing 102, proximate to trigger 108, and/or a guard of housing 102. Control interface 110 may be electrically, mechanically, and/or electronically coupled to processing circuit 202. In various embodiments, in response to control interface 110 comprising electronic properties or components, control interface 110 may be electrically coupled to a power supply of projectile launcher 100. Control interface 110 may receive power (e.g., electrical current) from the power supply to power the electronic properties or components.

Control interface 110 may be electronically or mechanically coupled to trigger 108. For example, and as discussed further herein, control interface 110 may function as a safety mechanism. In response to control interface 110 being set to a “safety mode,” projectile launcher 100 may be unable to launch projectile(s) from magazine 104. For example, control interface 110 may provide a signal (e.g., a control signal) to a processing circuit of projectile launcher 100 instructing processing circuit to disable deployment of projectile(s) from magazine 104. As a further example, control interface 110 may electronically or mechanically prohibit trigger 108 from activating (e.g., prevent or disable a user from depressing trigger 108; prevent trigger 108 from launching a projectile(s) P; etc.). Additionally, control interface 110 may cause one or more indications to be provided to the simulation environment. For example, setting projectile launcher 100 to a “safety mode” or an “active mode” may be reported to the simulation environment such that activation of trigger 108 prevents or enables, respectively, simulated deployment of projectile(s) from projectile launcher 100.

Control interface 110 may comprise any suitable electronic or mechanical component capable of enabling selection of firing modes. For example, control interface 110 may comprise a fire mode selector switch, a safety switch, a safety catch, a rotating switch, a selection switch, a selective firing mechanism, and/or any other suitable mechanical control. As a further example, control interface 110 may comprise a slide, such as a handgun slide, a reciprocating slide, or the like. As a further example, control interface 110 may comprise a touch screen, user interface or display, or similar electronic visual component.

The safety mode may be configured to prohibit deployment and/or simulated deployment of a projectile from magazine 104 in projectile launcher 100. For example, in response to a user selecting the safety mode, control interface 110 may transmit a safety mode instruction to a processing circuit of projectile launcher 100 and/or a simulation environment. In response to receiving the safety mode instruction, the processing circuit may prohibit deployment of a projectile from magazine 104 and/or the simulation environment may suppress simulation of a projectile being deployed from magazine 104. The processing circuit and/or the simulation environment may prohibit deployment until a further instruction is received from control interface 110 (e.g., a firing mode instruction). As previously discussed, control interface 110 may also, or alternatively, interact with trigger 108 to prevent activation of trigger 108. In various embodiments, the safety mode may also be configured to prohibit deployment of a stimulus signal from a signal generator of projectile launcher 100, such as, for example, a local delivery.

The firing mode may be configured to enable deployment and/or simulated deployment of one or more projectiles from magazine 104 in projectile launcher 100. For example, and in accordance with various embodiments, in response to a user selecting the firing mode, control interface 110 may transmit a firing mode instruction to a processing circuit. In response to receiving the firing mode instruction, the processing circuit may enable deployment of a projectile from magazine 104. Alternatively, the firing mode instruction may cause the processing signal to transmit an indication that projectile launcher 100 has been placed in the firing mode to the simulation environment. In that regard, in response to trigger 108 being activated, the processing circuit may cause the deployment of one or more projectiles and/or transmission of a deployment signal to the simulation environment. Additionally, the processing circuit may enable deployment and/or continue transmitting deployment indication(s) in response to activation of trigger 108 until a further instruction is received from control interface 110 (e.g., a safety mode instruction). As a further example, and in accordance with various embodiments, in response to a user selecting the firing mode, control interface 110 may also mechanically (or electronically) interact with trigger 108 of projectile launcher 100 to enable activation of trigger 108.

In various embodiments, and with reference to FIG. 1B, a handle 120 is disclosed. Handle 120 may be similar to, or have similar aspects and/or components with, any projectile launcher and/or handle discussed herein. Handle 120 may comprise a housing 122 and a barrel 124. The housing 122 of handle 120 may further comprise a trigger 126, a control interface 128, a handle end 130, and a deployment end 132. It should be further noted that any of the one or more components of projectile launcher 100 may be located in any suitable position within, or external to, housing 122. It should be noted that housing 122 may be configured in a manner similar to housing 102, trigger 126 may be configured in a manner similar to trigger 108, and control interface 128 may be configured similar to control interface 110.

In various embodiments, handle 120 may be configured to simulate a projectile launcher (e.g., projectile launcher 100) for a simulation environment. In particular, handle 120 (and projectile launcher 100) may be configured to provide bearing information for the simulation environment that includes a targeting axis that extends between handle end 130 and deployment end 132 along barrel 124. Bearing information may further indicate pitch information (e.g., is barrel 124 pitched upward or downward relative to a level plane) and/or rotational information of handle 120 relative to the targeting axis. It should be noted that handle 120 (and/or projectile launcher 100) may be configured to report the bearing information to the simulation environment. Alternatively, the simulation environment may be configured to capture the bearing information of the handle 120.

In various embodiments, projectile launcher 100 may comprise a first set of sensors 116 and a second set of sensors 118. First set of sensors 116 may be associated with a leading edge of projectile launcher 100 at deployment end 114. Similarly, second set of sensors 118 may be associated with a trailing edge of projectile launcher 100 at handle end 112. First set of sensors 116 and/or second set of sensors 118 may be configured as optical sensors that capture light level, luminance, total luminance, and/or other optical information associated with the leading edge and trailing edge of projectile launcher 100. First set of sensors 116 may comprise one or more optical sensors disposed proximate to deployment end 114 to capture optical information associated with deployment end 114. Additionally, and where first set of sensors 116 comprises two or more optical sensors, optical information captured by the first set of sensors 116 may be reported on an averaged basis from the first set of sensors 116 and/or an individual basis from the individual optical sensors of first set of sensors 116. Similarly, second set of sensors 118 may comprise one or more optical sensors disposed proximate to handle end 112 to capture optical information associated with handle end 112. Further, and where second set of sensors 118 comprises two or more optical sensors, optical information captured by the second set of sensors 118 may be reported on an averaged basis from the second set of sensors 118 and/or an individual basis from the individual optical sensors of second set of sensors 118. It should be noted that first set of sensors 116 may be comprised of one or more sensors separate from second set of sensors 118. Alternatively, or in addition, first set of sensors 116 may share one or more sensors with second set of sensors 118.

In various embodiments, and similar to projectile launcher 100, handle 120 may comprise a first set of sensors 134 and a second set of sensors 136. First set of sensors 134 may be associated with a leading edge of handle 120 at deployment end 132. Similarly, second set of sensors 136 may be associated with a trailing edge of handle 120 at handle end 130. First set of sensors 134 and/or second set of sensors 136 may be configured as optical sensors that capture light level, luminance, total luminance, and/or other optical information associated with the leading edge and trailing edge of handle 120. First set of sensors 134 may comprise one or more optical sensors disposed proximate to deployment end 132 to capture optical information associated with deployment end 132. Additionally, and where first set of sensors 134 comprises two or more optical sensors, optical information captured by the first set of sensors 134 may be reported on an averaged basis from the first set of sensors 134 and/or an individual basis from the individual optical sensors of first set of sensors 134. Similarly, second set of sensors 136 may comprise one or more optical sensors disposed proximate to handle end 130 to capture optical information associated with handle end 130. Further, and where second set of sensors 136 comprises two or more optical sensors, optical information captured by the second set of sensors 136 may be reported on an averaged basis from the second set of sensors 136 and/or an individual basis from the individual optical sensors of second set of sensors 136.

In various embodiments, barrel 124 may comprise a top surface 138, one or more angled surfaces 140, one or more side surfaces 142, and a bottom surface 144. In particular, barrel 124 may be at least partially defined by a first side surface 142 that extends between top surface 138 and bottom surface 144 on a first side of handle 120. Similarly, barrel 124 may be at least partially defined by a second side surface 142 that extends between top surface 138 and a bottom surface 144 on a second side of handle 120, the second side opposite the first side. Additionally, a first angled surface 140 may extend between top surface 138 and a side surface 142 to at least partially define a first side of barrel 124. Similarly, a second angled surface 140 may extend between top surface 138 and a side surface 142 to at least partially define a second side of barrel 124, the second side opposite the first side.

In various embodiments, first set of sensors 134 may be disposed on top surface 138. Similarly, second set of sensors 136 may be disposed on top surface 138. Alternatively, or in addition, first set of sensors 134 may be disposed on one or more angled surfaces 140 and/or one or more side surfaces 142. Similarly, second set of sensors 136 may be disposed on one or more angled surfaces 140 and one or more side surfaces 142. Optical sensors of first set of sensors 134 and second set of sensors 136 may be disposed to capture optical information incident to individual surfaces of handle 120. For example, optical sensors disposed on top surface 138 may capture optical information incident to top surface 138 (e.g., optical information may be captured from light sources and/or other optical information sources that top surface 138 is exposed to). In an additional example, optical sensors disposed on one or more angled surfaces 140 may capture optical information incident to one or more angled surfaces 140. In additional examples, optical sensors may be disposed on one or more side surfaces 142 and/or bottom surface 144 to capture optical information incident to one or more side surfaces 142 and/or bottom surface 144.

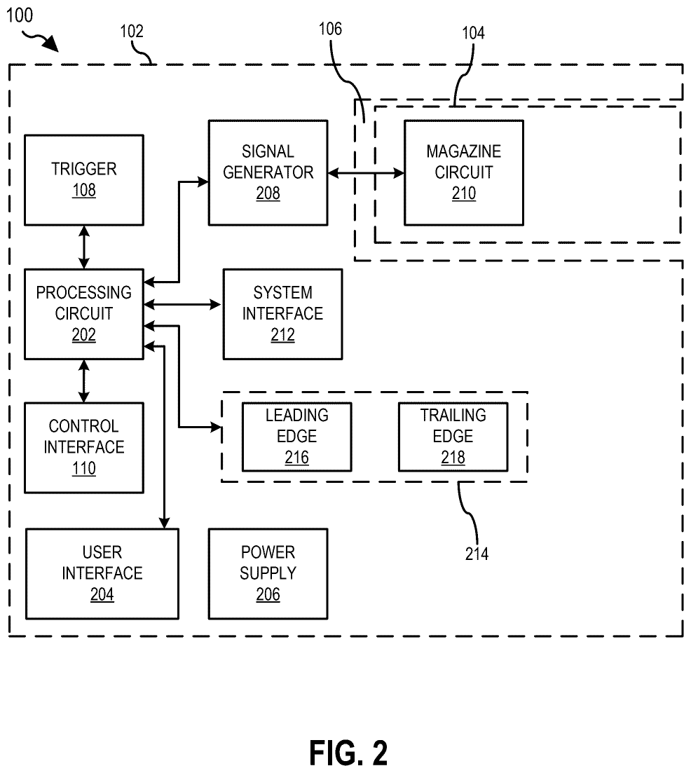

In various embodiments, and with reference to FIG. 2, a projectile launcher 100 (and/or a handle 120) is disclosed. As depicted by FIGS. 1A and 1B projectile launcher 100 may comprise housing 102, magazine 104, magazine receiver 106, trigger 108, control interface 110, and/or other components. Similarly, handle 120 may comprise housing 122, barrel 124, trigger 126, control interface 128, and/or other components. Additionally, projectile launcher 100 and/or handle 120 may comprise processing circuit 202, user interface 204, power supply 206, and/or signal generator 208. Further, projectile launcher 100 and/or handle 120 may be communicatively associated with magazine circuit 210 and/or system interface 212. Projectile launcher 100 and/or handle 120 may comprise a sensor circuit 214, sensor circuit 214 further comprising leading edge sensor 216 and trailing edge sensor 218.

In various embodiments, processing circuit 202 may comprise any circuitry, electrical components, electronic components, software, and/or the like configured to perform various operations and functions discussed herein. For example, processing circuit 202 may comprise a processing circuit, a processor, a digital signal processor, a microcontroller, a microprocessor, an application specific integrated circuit (ASIC), a programmable logic device, logic circuitry, state machines, MEMS devices, signal conditioning circuitry, communication circuitry, a computer, a computer-based system, a radio, a network appliance, a data bus, an address bus, and/or any combination thereof. In various embodiments, processing circuit 202 may include passive electronic devices (e.g., resistors, capacitors, inductors, etc.) and/or active electronic devices (e.g., op amps, comparators, analog-to-digital converters, digital-to-analog converters, programmable logic, SRCs, transistors, etc.). In various embodiments, processing circuit 202 may include data buses, output ports, input ports, timers, memory, arithmetic units, and/or the like.

In various embodiments, processing circuit 202 may include signal conditioning circuity. Signal conditioning circuitry may include level shifters to change (e.g., increase, decrease) the magnitude of a voltage (e.g., of a signal) before receipt by processing circuit 202 or to shift the magnitude of a voltage provided by processing circuit 202.

In various embodiments, processing circuit 202 may be configured to control and/or coordinate operation of some or all aspects of projectile launcher 100 and/or handle 120. For example, processing circuit 202 may include (or be in communication with) memory configured to store data, programs, and/or instructions. The memory may comprise a tangible non-transitory computer-readable memory. Instructions stored on the tangible non-transitory memory may allow processing circuit 202 to perform various operations, functions, and/or steps, as described herein.

In various embodiments, the memory may comprise any hardware, software, and/or database component capable of storing and maintaining data. For example, a memory unit may comprise a database, data structure, memory component, or the like. A memory unit may comprise any suitable non-transitory memory known in the art, such as, an internal memory (e.g., random access memory (RAM), read-only memory (ROM), solid state drive (SSD), etc.), removable memory (e.g., an SD card, an XD card, a CompactFlash card, etc.), or the like.

Processing circuit 202 may be configured to provide and/or receive electrical signals whether digital and/or analog in form. Processing circuit 202 may provide and/or receive digital information via a data bus using any protocol. Processing circuit 202 may receive information, manipulate the received information, and provide the manipulated information. Processing circuit 202 may store information and retrieve stored information. Information received, stored, and/or manipulated by processing circuit 202 may be used to perform a function, control a function, and/or to perform an operation or execute a stored program.

Processing circuit 202 may control the operation and/or function of other circuits and/or components of projectile launcher 100 and/or handle 120. Processing circuit 202 may receive status information regarding the operation of other components, perform calculations with respect to the status information, and provide commands (e.g., instructions) to one or more other components. Processing circuit 202 may command another component to start operation, continue operation, alter operation, suspend operation, cease operation, or the like. Commands and/or status may be communicated between processing circuit 202 and other circuits and/or components via any type of bus (e.g., SPI bus) including any type of data/address bus.

In various embodiments, processing circuit 202 may be mechanically and/or electronically coupled to trigger 108 (and/or trigger 126). Processing circuit 202 may be configured to detect an activation, actuation, depression, input, etc. (collectively, an “activation event”) of trigger 108. In response to detecting the activation event, processing circuit 202 may be configured to perform various operations and/or functions, as discussed further herein. Processing circuit 202 may also include a sensor (e.g., a trigger sensor) attached to trigger 108 and configured to detect an activation event of trigger 108. The sensor may comprise any suitable sensor, such as a mechanical and/or electronic sensor capable of detecting an activation event in trigger 108 and reporting the activation event to processing circuit 202.

In various embodiments, processing circuit 202 may be mechanically and/or electronically coupled to control interface 110 (and/or control interface 128). Processing circuit 202 may be configured to detect an activation, actuation, depression, input, etc. (collectively, a “control event”) of control interface 110. In response to detecting the control event, processing circuit 202 may be configured to perform various operations and/or functions, as discussed further herein. Processing circuit 202 may also include a sensor (e.g., a control sensor) attached to control interface 110 and configured to detect a control event of control interface 110. The sensor may comprise any suitable mechanical and/or electronic sensor capable of detecting a control event in control interface 110 and reporting the control event to processing circuit 202.

In various embodiments, processing circuit 202 may be electrically and/or electronically coupled to power supply 206. Processing circuit 202 may receive power from power supply 206. The power received from power supply 206 may be used by processing circuit 202 to receive signals, process signals, and transmit signals to various other components in projectile launcher 100. Processing circuit 202 may use power from power supply 206 to detect an activation event of trigger 108 (trigger 126), a control event of control interface 110 (control interface 128), or the like, and generate one or more control signals in response to the detected events. The control signal may be based on the control event and the activation event. The control signal may be an electrical signal.

In various embodiments, power supply 206 may be configured to provide power to various components of projectile launcher 100 (and/or handle 120). For example, power supply 206 may provide energy for operating the electronic and/or electrical components (e.g., parts, subsystems, circuits, etc.) of projectile launcher 100 and/or one or more magazine 104. Power supply 206 may provide electrical power. Providing electrical power may include providing a current at a voltage. Power supply 206 may be electrically coupled to processing circuit 202 and/or signal generator 208. In various embodiments, in response to a control interface comprising electronic properties and/or components, power supply 206 may be electrically coupled to the control interface 110. In various embodiments, in response to trigger 108 comprising electronic properties or components, power supply 206 may be electrically coupled to trigger 108. Power supply 206 may provide an electrical current at a voltage. Electrical power from power supply 206 may be provided as a direct current (“DC”). Electrical power from power supply 206 may be provided as an alternating current (“AC”). Power supply 206 may include a battery. The energy of power supply 206 may be renewable or exhaustible, and/or replaceable. For example, power supply 206 may comprise one or more rechargeable or disposable batteries. In various embodiments, the energy from power supply 206 may be converted from one form (e.g., electrical, magnetic, thermal) to another form to perform the functions of a system.

Power supply 206 may provide energy for performing the functions of projectile launcher 100 and/or handle 120. For example, power supply 206 may provide the electrical current to signal generator 208 that utilized to generate one or more signals that are reported to the simulation environment (e.g., ignition signal, stimulus signal, etc.). Power supply 206 may provide the energy for other signals, including an ignition signal, as discussed further herein. Alternatively, or in addition, power supply 206 may provide energy to signal generator 208 for generating one or more indications that are provided to a simulation environment associated with projectile launcher 100 and/or handle 120. In particular, and based at least on projectile launcher 100 and/or handle 120 being associated with a simulation environment, the one or more indications generated by signal generator 208 may be provided to the simulation environment by magazine circuit 210 and/or system interface 212. Additionally, one or more signals (e.g., the stimulus signal, the ignition signal, one or more additional signals provided by signal generator 208, etc.) may be converted to one or more indications and transmitted to the simulation environment by at least one of processing circuit 202, magazine circuit 210, and/or system interface 212.

In various embodiments, processing circuit 202 may be electrically and/or electronically coupled to signal generator 208. Processing circuit 202 may be configured to transmit or provide control signals to signal generator 208 in response to detecting an activation event of trigger 108. Alternatively, or in addition, processing circuit 202 may be configured to cause signal generator 208 to provide one or more indications to the simulation environment in response to detecting the activation event. Multiple control signals may be provided from processing circuit 202 to signal generator 208 in series. In response to receiving the control signal, signal generator 208 may be configured to perform various functions and/or operations, as discussed further herein.

In various embodiments, signal generator 208 may be configured to receive one or more control signals from processing circuit 202. Signal generator 208 may provide an ignition signal to magazine 104 and/or magazine circuit 210. Signal generator 208 may be electrically and/or electronically coupled to processing circuit 202, magazine circuit 210, and/or magazine 104. Signal generator 208 may be electrically coupled to power supply 206. Signal generator 208 may use power received from power supply 206 to generate an ignition signal. For example, signal generator 208 may receive an electrical signal from power supply 206 that has first current and voltage values. Signal generator 208 may transform the electrical signal into an ignition signal having second current and voltage values. The transformed second current and/or the transformed second voltage values may be different from the first current and/or voltage values. The transformed second current and/or the transformed second voltage values may be the same as the first current and/or voltage values. Signal generator 208 may temporarily store power from power supply 206 and rely at least in part on the stored power to provide the ignition signal. Signal generator 208 may also rely at least in part on received power from power supply 206 to provide the ignition signal, without needing to temporarily store power.

Signal generator 208 may be controlled at least in part by processing circuit 202. In various embodiments, signal generator 208 and processing circuit 202 may be separate components (e.g., physically distinct and/or logically discrete). Signal generator 208 and processing circuit 202 may be a single component. For example, a control circuit within housing 102 may at least include signal generator 208 and processing circuit 202. The control circuit may also include other components and/or arrangements, including those that further integrate corresponding function of these elements into a single component or circuit, as well as those that further separate one or more functions into separate components or circuits.

In various embodiments, and responsive to receipt of a signal indicating activation of trigger 108 (e.g., an activation event, an activation signal, etc.), processing circuit 202 may provide an ignition signal to magazine 104, magazine circuit 210, and/or a simulation environment communicatively associated with projectile launcher 100 (and/or handle 120). For example, signal generator 208 may provide an electrical signal as an ignition signal to magazine 104 in response to receiving a control signal from processing circuit 202. In various embodiments, the ignition signal may be separate and distinct from a stimulus signal. For example, a stimulus signal in projectile launcher 100 may be provided to a different circuit within magazine 104, relative to a circuit to which an ignition signal is provided. Signal generator 208 may be configured to generate a stimulus signal. In various embodiments, a second, separate signal generator, component, or circuit (not shown) within housing 102 may be configured to generate the stimulus signal. Signal generator 208 may also provide a ground signal path for magazine 104, thereby completing a circuit for an electrical signal provided to magazine 104 by signal generator 208. The ground signal path may also be provided to magazine 104 by other elements in housing 102, including power supply 206.

In various embodiments, projectile launcher 100 may further comprise one or more user interfaces 204. A user interface 204 may be configured to receive an input from a user of projectile launcher 100 (and/or handle 120) and/or transmit an output to the user of projectile launcher 100. User interface 204 may be located in any suitable location on or in housing 102 (and/or housing 122). For example, user interface 204 may be coupled to an outer surface of housing 102 or extend at least partially through the outer surface of housing 102. User interface 204 may be electrically, mechanically, and/or electronically coupled to processing circuit 202. In various embodiments, in response to user interface 204 comprising electronic or electrical properties or components, user interface 204 may be electrically coupled to power supply 206. User interface 204 may receive power (e.g., electrical current) from power supply 206 to power the electronic properties or components.

In various embodiments, user interface 204 may comprise one or more components configured to receive an input from a user. For example, user interface 204 may comprise one or more of an audio capturing module (e.g., microphone) configured to receive an audio input, a visual display (e.g., touchscreen, LCD, LED, etc.) configured to receive a manual input, a mechanical interface (e.g., button, switch, etc.) configured to receive a manual input, and/or the like. In various embodiments, user interface 204 may comprise one or more components configured to transmit or produce an output. For example, user interface 204 may comprise one or more of an audio output module (e.g., audio speaker) configured to output audio, a light-emitting component (e.g., flashlight, laser guide, etc.) configured to output light, a visual display (e.g., touchscreen, LCD, LED, etc.) configured to output a visual, and/or the like.

In various embodiments, processing circuit 202 may be electrically and/or electronically coupled to magazine circuit 210 and/or system interface 212. Processing circuit 202 may be configured to transmit or provide one or more control signals to magazine circuit 210 (e.g., via signal generator 208) and/or system interface 212 in response to detecting an activation event of trigger 108. Processing circuit 202 may cause one or more indications associated with the one or more control signals to be provided provide to the simulation environment in response to detecting the activation event. Multiple control signals may be provided from processing circuit 202 to magazine circuit 210 and/or system interface 212 in series. In response to receiving the control signal, magazine circuit 210 and/or system interface 212 may be configured to perform various functions and/or operations. Alternatively, or in addition, magazine circuit 210 and/or system interface 212 may cause the simulation environment to perform various functions and/or operations in response to the one or more control signals.

In various embodiments, projectile launcher 100 and/or handle 120 may comprise magazine circuit 210 and/or system interface 212 that enables one or more indications to be provided, from at least processing circuit 202, to a simulation environment (and/or a simulation system managing the simulation environment). The one or more indications may comprise one or more control signals generated by processing circuit 202, one or more ignition signals generated by signal generator 208, one or more interface signals generated by processing circuit 202, and/or one or more additional signals generated by projectile launcher 100 and/or handle 120. For example, magazine circuit 210 may be configured to communicatively connect processing circuit 202 with the simulation environment. Alternatively, magazine circuit 210 may cause processing circuit 202 to establish a connection with the simulation environment (e.g., via system interface 212). For example, magazine circuit 210 may provide one or more indications to processing circuit 202 and/or a control circuit of projectile launcher 100 and/or handle 120 that cause a connection to be established with the simulation environment via system interface 212, wherein system interface 212 is configured as a communication interface.

In various embodiments, sensor circuit 214 may comprise of a set of leading edge sensors 216 and a set of trailing edge sensors 218. Additionally, sensor circuit 214 may be configured to provide sensor information associated with the set of leading edge sensors 216 and/or the set of trailing edge sensors 218 to processing circuit 202. Further, the sensor information provided by sensor circuit 214 may be provided to the simulation environment by processing circuit 202. For example, the set of leading edge sensors 216 and/or the set of trailing edge sensors 218 may be optical sensors that provide optical information to processing circuit 202 utilized to determine a holstering state, a drawn state, and/or other state-related information for projectile launcher 100 and/or handle 120.

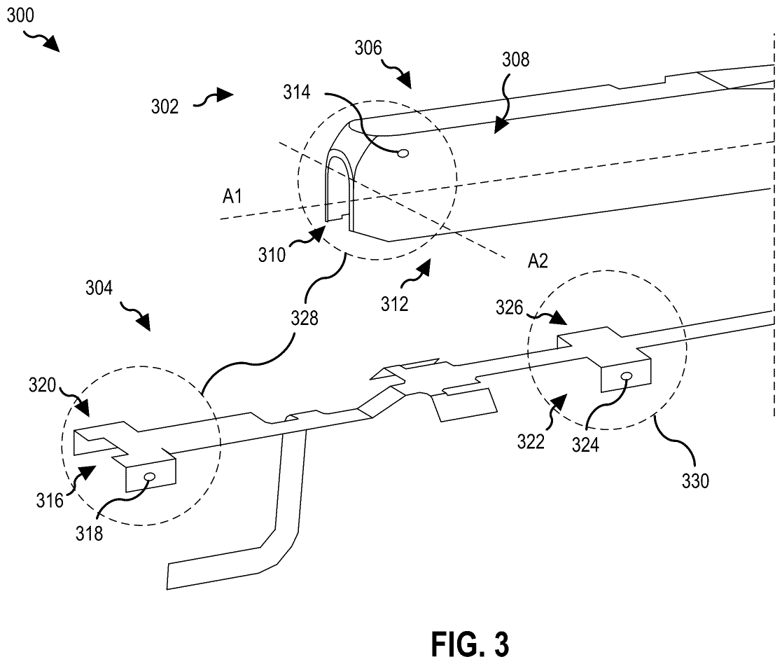

In various embodiments, and with reference to FIG. 3, a portion 300 of a projectile launcher and/or handle is disclosed. It should be noted that portion 300 may similar to, or have similar aspects and/or components with, portion(s) of any projectile launcher and/or handle discussed herein. Portion 300 may be comprised of at least an upper housing 302 and a circuit 304. Upper housing 302 may define at least a portion of an upper surface and/or one or more side surfaces of a projectile launcher and/or a handle (e.g., top surface 138, one or more angled surfaces 140, one or more side surfaces 142, etc.) Additionally, circuit 304 may be configured to perform various functions associated with operation of the projectile launcher and/or the handle. Circuit 304 may be installed within upper housing 302 and/or other housing component of the projectile launcher and/or the handle. Circuit 304 may comprise and/or interface with various circuits including at least a control circuit of the projectile launcher and/or the handle, processing circuit 202, signal generator 208, magazine circuit 210, a communication circuit, sensor circuit 214, and/or other circuits associated with the projectile launcher and/or the handle.

In various embodiments, upper housing 302 may be shaped to imitate a barrel and/or other portion of a firearm, a conducted energy weapon (CEW), and/or other projectile launcher for a simulation environment. Alternatively, or in addition, upper housing 302 may be a portion of a projectile launcher. Similar to the discussion of FIGS. 1A and 1B, a projectile launcher and/or a housing may comprise a top surface 306 (e.g., top surface 138) and one or more side surfaces 308 (e.g., one or more angled surfaces 140, one or more side surfaces 142, etc.). Additionally, a front opening 310 may permit a barrel to extend forward from upper housing 302, one or more detectors to be exposed by upper housing 302, and/or one or more emitters to be exposed by upper housing 302. Further, a lower opening 312 may be configured to receive a lower housing of the projectile launcher and/or handle.

In various embodiments, upper housing 302 may be configured to receive and secure circuit 304. In particular, circuit 304 may be installed within upper housing 302 via at least lower opening 312 such that one or more contacts and/or connectors (not depicted) couple with various internal components of the projectile launcher and/or handle. For example, circuit 304 may couple with and communicatively connect processing circuit 202 power supply 206, signal generator 208, sensor circuit 214, and/or other components of the projectile launcher and/or handle. Similarly, circuit 304 may couple with and communicatively connect various interfaces (e.g., trigger 108, control interface 110, user interface 204, magazine circuit 210, system interface 212, etc.) associated with the projectile launcher and/or the handle.

In various embodiments, circuit 304 may be configured such that one or more sensor apertures 314 are aligned with one or more sensors of circuit 304 based at least on circuit 304 being installed within upper housing 302. In particular, circuit 304 may comprise a first set of sensors 316 and a second set of sensors 322. The first set of sensors 316 may comprise at least a first optical sensor 318 and a second optical sensor 320 that are disposed proximate a leading edge 328. The second set of sensors 322 may comprise at least a third optical sensor 324 and a fourth optical sensor 326 that are disposed proximate to trailing edge 330. Upper housing 302 may comprise one or more first sensor apertures 314 that are disposed proximate to leading edge 328 when circuit 304 is installed within housing 302. Upper housing 302 may comprise one or more second sensor apertures (not depicted) that are disposed proximate to trailing edge 330 when circuit 304 is installed within housing 302. First optical sensor 318 and second optical sensor 320 may receive optical information via one or more apertures 314 and/or may extend through one or more apertures 314 to capture optical information. Similarly, third optical sensor 324 and fourth optical sensor 326 may receive optical information via one or more apertures 314 and/or may extend through one or more apertures 314 to capture optical information.

In various embodiments, leading edge 328 and the first set of sensors 316 may be disposed along a first axis A1 of the projectile launcher and/or handle. First axis A1 may be disposed coaxial and/or parallel to a barrel, a simulated barrel, upper housing 302, and/or other component of projectile launcher and/or housing that is aligned to a targeted point of the projectile launcher and/or housing. Leading edge 328 and the first set of sensors 316 may be disposed proximate to front opening 310. Additionally, first optical sensor 318 may be spaced from second optical sensor 320 along at least a second axis A2 that extends through at least one or more side surfaces 308. One or more apertures may be disposed on at least one of top surface 306 and/or one or more side surfaces 308. Accordingly, first set of sensors 316 may capture optical information associated with and/or incident to at least one of top surface 306 and/or one or more side surfaces 308 proximate to front opening 310 of housing 302. Leading edge 328 may be associated with a deployment end (e.g., deployment end 114, deployment end 132, etc.) of the projectile launcher and/or handle.

In various embodiments, first optical sensor 318 and second optical sensor 320 may be disposed to capture optical information incident to a surface of at least upper housing 302. First optical sensor 318 and second optical sensor 320 may be disposed on and/or in association with a single surface of upper housing 302 (e.g., both first optical sensor 318 and second optical sensor 320 are disposed on top surface 306). Alternatively, first optical sensor 318 and second optical sensor 320 may be disposed on and/or associated with a plurality of surfaces of upper housing 302. For example, first optical sensor 318 may be disposed on a first side surface of the one or more side surfaces 308 and second optical sensor 318 may be disposed on a second side surface of the one or more side surfaces 308. In an additional example, first optical sensor 318 may be disposed on top surface 306 and second optical sensor 320 may be disposed on a first side surface of the one or more side surfaces 308. Additionally, one or more additional optical sensors of the first set of sensors 316 may be disposed proximate to first optical sensor 318, second optical sensor 320, and leading edge 328. Further, the first set of optical sensors 316 may be disposed proximate to a single point on the first axis A1 defined as leading edge 328. For example, first optical sensor 318 and second optical sensor 320 of the first set of optical sensors 316 may be disposed at a leading edge point along the first axis A1. First optical sensor 318 and second optical sensor 320 of the first set of optical sensors 316 may be spaced along a second axis A2, perpendicular to the first axis A1, that extends through a first side surface and a second side surface of the one or more side surfaces 308.

In various embodiments, trailing edge 330 and the second set of sensors 322 may be disposed along a first axis A1 of the projectile launcher and/or handle. Trailing edge 330 and the second set of sensors 322 may be disposed opposite front opening 310 along first axis A1. Additionally, third optical sensor 324 may be spaced from fourth optical sensor 326 along at least a second axis A2 that extends through at least one or more side surfaces 308. One or more apertures may be disposed on at least one of top surface 306 and/or one or more side surfaces 308. Accordingly, second set of sensors 322 may capture optical information associated with and/or incident to at least one of top surface 306 and/or one or more side surfaces 308 opposite front opening 310 and/or at a rear portion of housing 302. Trailing edge 330 may be associated with a handle end (e.g., handle end 112, handle end 130, etc.) of the projectile launcher and/or handle. For example, third optical sensor 324 and fourth optical sensor 326 of the second set of sensors 322 may be disposed at a trailing edge point along the first axis A1. Third optical sensor 324 and fourth optical sensor 326 may be spaced along a third axis, perpendicular to the first axis A1 and parallel to the second axis A2, that extends through the first side surface and the second side surface of the one or more side surfaces 308.

In various embodiments, third optical sensor 324 and fourth optical sensor 326 may be disposed to capture optical information incident to a surface of at least upper housing 302. Third optical sensor 324 and fourth optical sensor 326 may be disposed on and/or in association with a single surface of upper housing 302 (e.g., both third optical sensor 324 and fourth optical sensor 326 are disposed on top surface 306). Alternatively, third optical sensor 324 and fourth optical sensor 326 may be disposed on and/or associated with a plurality of surfaces of upper housing 302. For example, third optical sensor 324 may be disposed on a first side surface of the one or more side surfaces 308 and fourth optical sensor 326 may be disposed on a second side surface of the one or more side surfaces 308. In an additional example, third optical sensor 324 may be disposed on top surface 306 and fourth optical sensor 326 may be disposed on a first side surface of the one or more side surfaces 308. Additionally, one or more additional optical sensors of the second set of sensors 322 may be disposed proximate to third optical sensor 324, fourth optical sensor 326, and trailing edge 330. Further, the second set of optical sensors 322 may be disposed proximate to a single point on the first axis A1 defined as trailing edge 330.

In various embodiments, at least first optical sensor 318, second optical sensor 320, third optical sensor 324, and/or fourth optical sensor 326 may be configured as luminance sensors. When configured as luminance sensors, first optical sensor 318, second optical sensor 320, third optical sensor 324, and/or fourth optical sensor 326 may capture optical information comprising an intensity of light received at a surface per unit of area. The intensity of light received at a surface per unit of area may be referenced as luminance and/or total luminance. The optical information may be reported to at least a processing circuit, a system interface, a control circuit, and/or other circuit associated with the first set of sensors 316 and the second set of sensors 322.

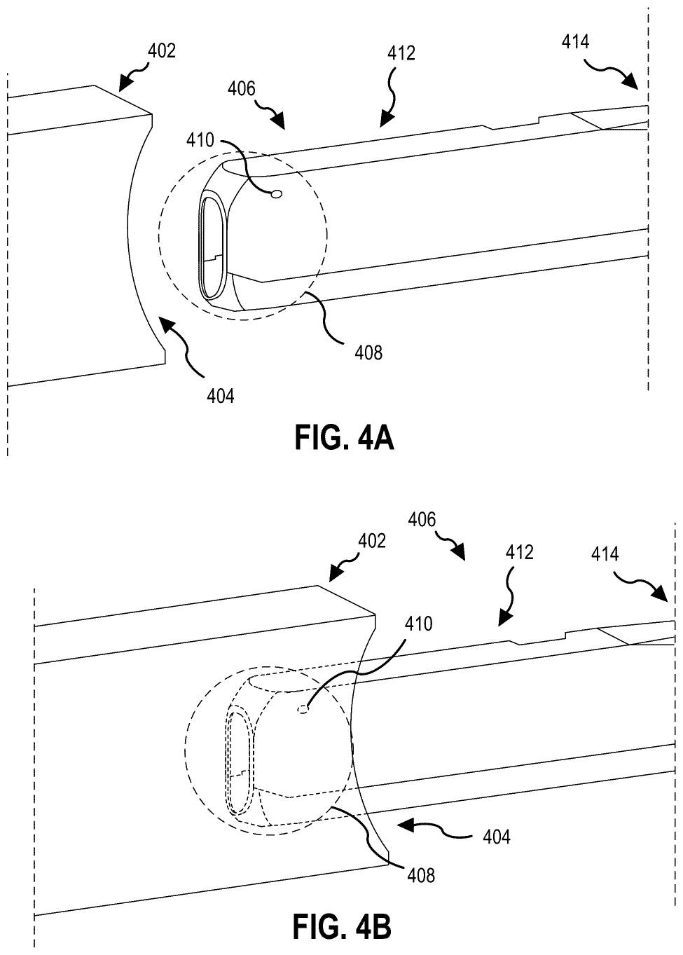

In various embodiments, and with reference to FIGS. 4A and 4B, a projectile launcher 406 and/or handle 406 is configured to fit within a holster 402 is disclosed. Additionally, handle 406, or a system associated with handle 406, may detect a holstering status of handle 406 within holster 402. It should be noted that the projectile launcher 406 and/or handle 406 may be similar to, or have similar aspects and/or components with, portion(s) of any projectile launcher and/or handle discussed herein. In particular, the projectile launcher 406 and/or handle 406 may be associated with a processing circuit (e.g., processing circuit 202) and/or a control circuit that determines a device state.

In various embodiments, and with reference to FIG. 4A, handle 406 may be separated from holster 402. In particular, leading edge 408 of handle 406 may be spaced from a holster opening 404 of holster 402. Separation of leading edge 408 from holster 402 may cause one or more leading edge sensors 410 to detect first optical information. First optical information may be associated with one or more leading edge sensors 410 being exposed to one or more light sources in an environment of handle 406.

In various embodiments, and with reference to FIG. 4A, handle 406 may be separated from holster 402 such that leading edge 408 and trailing edge 414 are exposed to one or more light sources. In particular, leading edge 408 and trailing edge 414 may be disposed proximate to a first portion and a second portion of upper portion 412 of handle 406. Leading edge 408 may be disposed proximate to a deployment end of handle 406 and trailing edge 414 may be disposed proximate to a handle end of handle 406. As noted above, one or more leading edge sensors 410 may capture first optical information at leading edge 408. Additionally, one or more trailing edge sensors (not depicted) may capture second optical information at trailing edge 414.

In various embodiments, a control circuit of handle 406 may be configured to determine a device state based at least on first optical information captured by one or more leading edge sensors 410 and second optical information captured by one or more trailing edge sensors. In particular, the control circuit of handle 406 may be configured to determine, manage, and maintain the device state of handle 406, the device state representing whether handle 406 is in a holstered state or an unholstered state. For example, the control circuit associated with handle 406 may be configured to determine that handle 406 is in a device state selected from at least one of: null (e.g., undefined, indefinite, neutral, etc.), holstered (e.g., handle 406 is holstered within holster 402), holstering (e.g., handle 406 is being holstered within holster 402 and/or is partially holstered within holster 402), unholstered (e.g., handle 406 is not holstered within holster 402), and unholstering (e.g., handle 406 is being unholstered from holster 402 and/or is partially holstered within holster 402). It should be noted that the null device state is determined to be a device state that is associated with an activation, initialization, and/or other power-on process of handle 406.

In various embodiments, the control circuit of handle 406 may determine that the device state of handle 406 is null based at least on whether previous optical information is available for at least one of one or more leading edge sensors 410 and/or one or more trailing edge sensors. In particular, the control circuit may be configured to determine device state independent of calibration. Generally, the control circuit may be configured to utilize optical information deltas between a first time and a second time to determine the device state. Additionally, the control circuit may utilize leading edge 408 and trailing edge 414 to interpret optical information deltas determined for at least one or more leading edge sensors 410 and one or more trailing edge sensors. Accordingly, and based on handle 406 being initialized, the control circuit may determine that previous optical information is unavailable for at least one or more leading edge sensors 410 and/or one or more trailing edge sensors. Further, the control circuit may determine that the device state is null based at least on the unavailability of previous optical information.

In various embodiments, and as depicted in FIG. 4A, handle 406 may be initialized separate from holster 402. In particular, initialization of handle 406 may cause one or more leading edge sensors 410 to capture initial first optical information at leading edge 408. Similarly, initialization of handle 406 may cause one or more trailing edge sensors to capture initial second optical information at trailing edge 414. Additionally, previous first optical information associated with leading edge 408 and previous second optical information associated with trailing edge 414 may be unavailable and cause control circuit to determine that handle 406 has a device state of null. It should be noted that initial first optical information may comprise one or more first information entries associated with individual sensors of the one or more leading edge sensors 410. Alternatively, or in addition, initial first optical information may comprise a first averaged value of one or more first information entries associated with individual sensors of the one or more leading edge sensors 410. Similarly, initial second optical information may comprise at least one of a second averaged value and/or one or more second information entries associated with individual sensors of the one or more trailing edge sensors associated with trailing edge 414.

In various embodiments, and as depicted in FIG. 4B, handle 406 may be inserted through holster opening 404 into holster 402. In particular, insertion of handle 406 within holster 402 may dispose at least leading edge 408 and one or more leading edge sensors 410 within an internal channel of holster 402. Disposing handle 406 within holster 402 may cause holster 402 to occlude one or more light sources from one or more leading edge sensors 410. Additionally, disposing handle 406 within holster 402 may dispose at least trailing edge 414 and one or more trailing edge sensors within the internal channel of holster 402. Further, disposing handle 406 within holster 402 may cause holster 402 to occlude one or more light sources from one or more trailing edge sensors.

In various embodiments, and as depicted in FIGS. 4A and 4B, handle 406 may be inserted within and withdrawn from holster 402. In particular, and at a first time, a control circuit of handle 406 may determine a first device state from initial first optical information associated with leading edge 408 and initial second optical information associated with trailing edge 414. Additionally, and at a second time, a control circuit of handle 406 may determine a second device state from additional first optical information associated with leading edge 408 and additional second optical information associated with trailing edge 414.

In various embodiments, a control circuit of handle 406 may be configured to determine whether handle 406 is holstered within or unholstered from holster 402. In particular, the control circuit may determine a first optical information delta, associated with leading edge 408, from initial first sensor information and additional first sensor information captured by one or more leading edge sensors 410. Similarly, the control circuit may determine a second optical information delta, associated with trailing edge 414, from initial second sensor information and additional second sensor information captured by one or more trailing edge sensors. Evaluation of the first optical information delta and the second optical information delta may be triggered by control circuit detecting a reduction in value for at least one of first optical information and/or second optical information (e.g., a derivative of luminance detected by one or more leading edge sensors 410 and/or one or more trailing edge sensors becomes negative indicating a downslope in luminance and/or total luminance is detected). Evaluation of the first optical information delta and the second optical information delta may be triggered by the reduction in value exceeding a threshold value. Similarly, evaluation of the first optical information delta and the second optical information delta may be triggered by control circuit detecting a increase in value for at least one of first optical information and/or second optical information (e.g., a derivative of luminance and/or total luminance detected by one or more leading edge sensors 410 and/or one or more trailing edge sensors becomes positive indicating an upslope in luminance detected). Evaluation of the first optical information delta and the second optical information delta may be triggered by the increase in value exceeding a threshold value.

In various embodiments, a control circuit of handle 406 may be configured to determine whether handle 406 is holstered within holster 402. In particular, the control circuit may determine the first optical information delta associated with leading edge 408 and the second optical information delta associated with trailing edge 414. Additionally, the control circuit may determine whether the first optical information delta satisfies a falling event threshold. The falling event threshold may be associated with a drop in luminance and/or total luminance indicating occlusion of an optical sensor from one or more light sources. Alternatively, or in addition, the falling event threshold may be associated with a drop in luminance and/or total luminance greater than ambient variation in luminance and/or total luminance caused by motion of the handle and/or surrounding objects in an environment. In response to the first optical information delta satisfying the falling event threshold, the control circuit may determine the first optical information delta is indicative of a falling leading edge event and that leading edge 408 of handle 406 is disposed within holster 402. Further, the control circuit may determine whether the second optical information delta satisfies the falling event threshold and/or an additional falling event threshold. In response to the second optical information delta satisfying the falling event threshold, the control circuit may determine the second optical information delta is indicative of a falling trailing edge event and that trailing edge 414 of handle 406 is disposed within holster 402. Accordingly, the control circuit may determine that the device state of handle 406 is holstered based at least on the falling leading edge event and/or the falling trailing edge event.

In various embodiments, a control circuit of handle 406 may be configured to determine whether handle 406 is being holstered within holster 402. In particular, the control circuit may determine the first optical information delta associated with leading edge 408 and the second optical information delta associated with trailing edge 414. Additionally, the control circuit may determine whether the first optical information delta and/or the second optical information delta satisfy a falling event threshold. In response to the control circuit determining, as recited above, that the first optical information delta indicates a falling leading edge event and the second optical information delta indicates a falling trailing edge event, the control circuit may report that handle 406 is holstered. In contrast, the control circuit may determine that the first optical information delta indicates a falling leading edge event and that the second optical information delta does not satisfy the falling event threshold. As a result, the control circuit may report that handle 406 is partially holstered and/or is being holstered at a time associated with the first optical information delta and the second optical information delta.

In various embodiments, a control circuit of handle 406 may be configured to determine whether handle 406 is unholstered from holster 402. In particular, the control circuit may determine the first optical information delta associated with leading edge 408 and the second optical information delta associated with trailing edge 414. Additionally, the control circuit may determine whether the first optical information delta satisfies a rising event threshold. The rising event threshold may be associated with an increase in luminance and/or total luminance indicating exposure of an optical sensor to one or more light sources. Alternatively, or in addition, the rising event threshold may be associated with an increase in luminance and/or total luminance greater than ambient variation in luminance and/or total luminance caused by motion of the handle and/or surrounding objects in an environment. In response to the first optical information delta satisfying the rising event threshold, the control circuit may determine the first optical information delta is indicative of a rising leading edge event and that leading edge 408 of handle 406 is separated from holster 402. Further, the control circuit may determine whether the second optical information delta satisfies the rising event threshold and/or an additional rising event threshold. In response to the second optical information delta satisfying the rising event threshold, the control circuit may determine the second optical information delta is indicative of a rising trailing edge event and that trailing edge 414 of handle 406 is separated from holster 402. Accordingly, the control circuit may determine that the device state of handle 406 is unholstered based at least on the rising leading edge event and/or the rising trailing edge event.

In various embodiments, a control circuit of handle 406 may be configured to determine whether handle 406 is being unholstered within holster 402. In particular, the control circuit may determine the first optical information delta associated with leading edge 408 and the second optical information delta associated with trailing edge 414. Additionally, the control circuit may determine whether the first optical information delta and/or the second optical information delta satisfy a rising event threshold. In response to the control circuit determining, as recited above, that the first optical information delta indicates a rising leading edge event and the second optical information delta indicates a rising trailing edge event, the control circuit may report that handle 406 is unholstered. In contrast, the control circuit may determine that the second optical information delta indicates a rising trailing edge event and that the first optical information delta does not satisfy the rising event threshold. As a result, the control circuit may report that handle 406 is partially unholstered and/or is being unholstered at a time associated with the first optical information delta and the second optical information delta.

In various embodiments, a control circuit of handle 406 may be configured to identify and report transitions between a holstered state and an unholstered state. As noted above, the control circuit may utilize detection of one or more rising events associated with leading edge 408 and/or trailing edge 414 to identify unholstering transitions. Additionally, the control circuit may utilize detection of one or more failing events associated with leading edge 408 and/or trailing edge 414 to identify holstering transitions. Further, the control circuit may determine the unholstering transition based at least on a previous device state being a holstered state. Similarly, the control circuit may determine the holstering transition based at least on a previous device state being an unholstered state.

In various embodiments, a control circuit of handle 406 may prioritize a rising event and/or a falling event in determining device state for handle 406. In particular, a previous device state may cause the control circuit to prioritize leading edge 408 or trailing edge 414 in determination of device state. For example, and based at least on the previous device state being holstered, the control circuit may prioritize determination of a rising leading edge event in determining the device state. Detection of a rising leading edge event subsequent to a previous device state being determined to be holstered may be interpreted as indicating a rising trailing edge event. Withdrawing leading edge 408 from holster 402 may require trailing edge 414 to be withdrawn from the holster prior to leading edge 408 for a selection of holster designs. Similarly, and based at least on the previous device state being unholstered, the control circuit may prioritize determination of a falling trailing edge event in determining the device state. Detection of a falling trailing edge event subsequent to a previous device state being determined to be unholstered may be interpreted as indicating a falling leading edge event. Inserting trailing edge 414 into holster 402 may require leading edge 408 to be inserted within the holster prior to trailing edge 414 for a selection of holster designs.

In various embodiments, a control circuit of handle 406 may be configured to report a device state of handle 406 to a simulation environment and/or a simulation system. In particular, control circuit may determine a device state of handle 406 based at least on a combination of previous device states, rising leading edge events, rising trailing edge events, falling leading edge events, and falling trailing edge events. The control circuit may be configured to report changes in device state after initialization of handle 406 such that the simulation environment and/or the simulation system receives a series of device state updates from handle 406. Alternatively, or in addition, the control circuit may be configured to periodically report a device state of handle 406 such that the simulation environment and/or the simulation system receives a series of device state reports that include one or more device state updates.

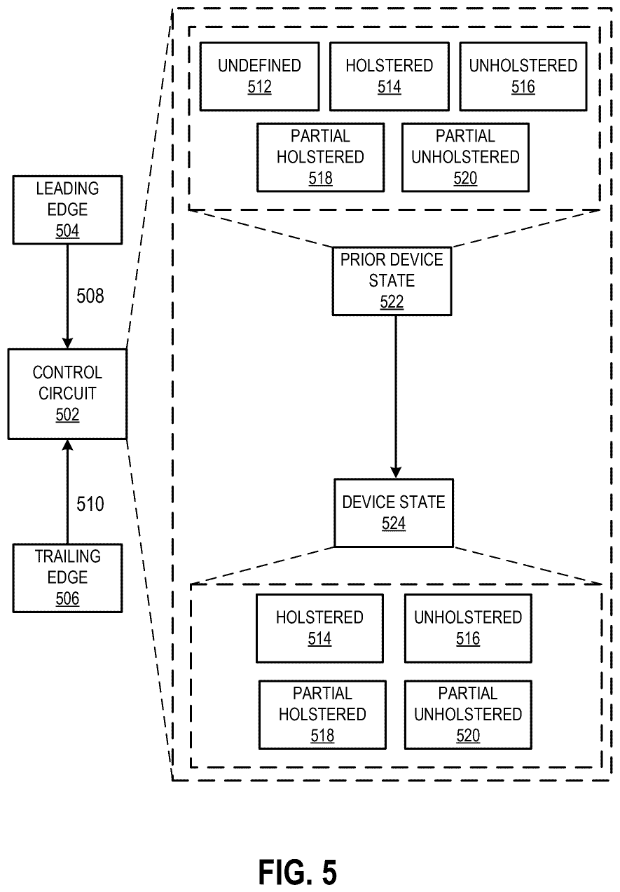

In various embodiments, and with reference to FIG. 5, a control circuit 502 may be configured to manage a device state for a simulation device (e.g. projectile launcher 100, handle 120, handle 406, etc.). It should be noted that control circuit 502 may be configured and/or operate similar to any other control circuit and/or processing circuit described above. Control circuit 502 may be communicatively associated with leading edge 504 and trailing edge 506. Leading edge 504 may be associated with and/or comprise one or more leading edge sensors. Leading edge 504 may provide one or more leading edge indications 508 to control circuit 502. Similarly, trailing edge 506 may provide one or more trailing edge indications 510 to control circuit 502.

In various embodiments, control circuit 502 may receive one or more leading edge indications 508 and/or one or more trailing edge indications 510 at a first time. In particular, leading edge 504 (e.g., one or more leading edge sensors associated with a deployment end and/or a simulated deployment end) may provide one or more leading edge indications 508 on a periodic, aperiodic, triggered, and/or other transmission basis. For example, leading edge 504 may provide the one or more leading edge indications 508 based at least on 1 millisecond, 10 milliseconds, 1 second, 2 seconds, 10 seconds, 30 seconds, 1 minute, 5 minutes, and/or other time period elapsing. Alternatively, or in addition, leading edge 504 may provide the one or more leading edge indications 508 based at least on a change in detected value determined by the one or more leading edge sensors (or a leading edge sensor circuit). The one or more leading edge indications 508 may be provided based at least on the change in detected value satisfying a threshold value associated with the leading edge 504. Similarly, trailing edge 506 (e.g., one or more trailing edge sensors associated with a handle end and/or a simulated handle end) may provide one or more trailing edge indications 510 on a periodic, aperiodic, triggered, and/or other transmission basis. For example, trailing edge 506 may provide the one or more trailing edge indications 510 based at least on 1 millisecond, 10 milliseconds, 1 second, 2 seconds, 10 seconds, 30 seconds, 1 minute, 5 minutes, and/or other time period elapsing. Alternatively, or in addition, trailing edge 506 may provide the one or more trailing edge indications 510 based at least on a change in detected value determined by the one or more trailing edge sensors (or a trailing edge sensor circuit). The one or trailing edge indications 510 may be provided based at least on the change in detected value satisfying a threshold value associated with the trailing edge 506.

In various embodiments, leading edge 504 may be configured to provide one or more leading edge indications 508 to control circuit 502. In particular, leading edge 504 may be associated with and/or comprise a leading edge sensor circuit. The leading edge sensor circuit may comprise one or more leading edge sensors that generate one or more leading edge optical indications. Additionally, the leading edge sensor circuit may be configured to perform signal processing, generation, and/or management. For example, the leading edge sensor circuit may average the one or more leading edge optical indications to generate the leading edge indication 508. Alternatively, or in addition, leading edge sensor circuit may transmit a set of the one or more leading edge optical indications as one or more leading edge indications 508 based at least on the set of the one or more leading edge optical indications satisfying a threshold. For example, the threshold may be associated with a threshold change in luminance and/or total luminance detected by the one or more leading edge sensors.

In various embodiments, and similar to leading edge 504, trailing edge 506 may be configured to provide one or more trailing edge indications 510 to control circuit 502. In particular, trailing edge 506 may be associated with and/or comprise a trailing edge sensor circuit. The trailing edge sensor circuit may comprise one or more trailing edge sensors that generate one or more trailing edge optical indications. Additionally, the trailing edge sensor circuit may be configured to perform signal processing, generation, and/or management. For example, the trailing edge sensor circuit may average the one or more trailing edge optical indications to generate the trailing edge indications 510. Alternatively, or in addition, trailing edge sensor circuit may transmit a set of the one or more trailing edge optical indications as one or more trailing edge indications 510 based at least on the set of the one or more trailing edge optical indications satisfying a threshold. For example, the threshold may be associated with a threshold change in luminance and/or total luminance detected by the one or more trailing edge sensors. For example, the threshold may be a rising event threshold utilized to determine and/or identify one or more rising edge events (e.g., rising leading edge event, rising trailing edge event, etc.) based at least on a minimum positive rate of change in luminance being exceeded and/or satisfied. For example, the threshold may be a falling event threshold utilized to determine and/or identify one or more falling edge events (e.g., falling leading edge event, falling trailing edge event, etc.) based at least on a minimum negative rate of change in luminance being exceeded and/or satisfied.

In various embodiments, control circuit 502 may utilize the one or more leading edge indications 508 and/or the one or more trailing edge indications 510 to determine a device state. In particular, control circuit 502 may receive the one or more leading edge indications 508 at a first time. Control circuit 502 may determine one or more prior leading edge indications received from leading edge 504 at a second time prior to the first time. Additionally, control circuit 502 may determine a leading edge delta based at least on the one or more leading edge indications 508 and the one or more prior leading edge indications. Further, control circuit 502 may determine whether the leading edge delta represents a rising leading edge event or a falling leading edge event based at least on a rising event threshold and a falling event threshold. Similarly, control circuit 502 may receive the one or more trailing edge indications 510 at the first time. Alternatively, or in addition, control circuit 502 may receive the one or more trailing edge indications at a third time different from the first time. Control circuit 502 may determine one or more prior trailing edge indications received from trailing edge 506 at the second time (or a fourth time different from the second time) prior to the first time (and/or the third time). Additionally, control circuit 502 may determine a trailing edge delta based at least on the one or more trailing edge indications 510 and the one or more prior trailing edge indications. Further, control circuit 502 may determine whether the trailing edge delta represents a rising trailing edge event or a falling trailing edge event based at least on a rising event threshold (alternatively, an additional rising event threshold associated with trailing edge 506) and a falling event threshold (alternatively, an additional falling event threshold associated with trailing edge 506). For example, control circuit 502 may determine one or more rising edge events (e.g., rising leading edge event, rising trailing edge event, etc.) based at least on the rising event threshold indicating that a minimum positive rate of change in luminance was satisfied. Similarly, control circuit 502 may determine one or more falling edge events (e.g., falling leading edge event, falling trailing edge event, etc.) based at least on the falling event threshold indicating that a minimum negative rate of change in luminance was satisfied.

In various embodiments, control circuit 502 may determine a device state from a set of potential device states. For example, control circuit 502 may be configured to determine whether the device state is an undefined state 512, a holstered state 514, an unholstered state 516, a partial holstered state 518, a partial unholstered state 520, and/or other state. Additional states may include a holstering state, an unholstering state, a transitory state, and/or other state. Control circuit 502 may determine that the device state is the holstered state 514 based at least on a trailing edge falling event being determined for trailing edge 506. Alternatively, or in addition, control circuit 502 may determine that the device state is the holstered state 514 based at least on a leading edge falling event being determined for leading edge 504 and the trailing edge falling event. Similarly, control circuit 502 may determine that the device state is the unholstered state 516 based at least on a leading edge rising event being determined for leading edge 504. Alternatively, or in addition, control circuit 502 may determine that the device state is the unholstered state 516 based at least on a trailing edge rising event being determined for trailing edge 506 and the leading edge rising event. Additionally, control circuit 502 may determine that the device state is the partially holstered state 518 based at least on a leading edge falling event being determined for leading edge 504. Alternatively, or in addition, control circuit 502 may determine that the device state is the partially holstered state 518 based at least on the leading edge falling event being determined without a trailing edge falling event being identified. Further, control circuit 502 may determine that the device state is the partially unholstered state 520 based at least on a trailing edge rising event being determined for trailing edge 504. Alternatively, or in addition, control circuit 502 may determine that the device state is the partially unholstered state 520 based at least on the trailing edge rising event being determined without a leading edge rising event being identified.

In various embodiments, control circuit 502 may determine that a device state is undefined state 512 from the set of potential device states. As previously noted, control circuit 502 may determine the device state based at least on one or more prior optical indications. However, on initialization (e.g., power on, activation, etc.) of control circuit 502, control circuit 502 may receive one or more leading edge indications 508 and/or one or more trailing edge indications 510 independent of one or more prior leading edge indications and/or one or more prior trailing edge indications. Additionally, receiving one or more leading edge indications 508 and/or one or more trailing edge indications 510 independent of one or more prior leading edge indications and/or one or more prior trailing edge indications may prevent control circuit 502 from determining the leading edge delta and/or the trailing edge delta. As a result, control circuit 502 may determine that the device state is undefined state 512 based at least on the leading edge delta and/or the trailing edge delta being undefined. Additionally, the device state may be determined as undefined state 512 based at least on control circuit 502 being unassociated with and/or independent from a previous device state. The device state may be determined to be unassociated with and/or independent from the previous device state based at least on a power off, power cycle, a period of time greater than a threshold duration, connection termination, and/or other deactivation of control circuit 502. Generally, the device state may be unassociated with and/or independent from the previous device state in response an intervening event that would permit a state transition to occur that control circuit would not detect (e.g., if control circuit 502 is power off, a state transition may be undetected and/or unrecognized).

In various embodiments, control circuit 502 may be associated with a prior device state 522. For example, and where one or more leading edge indications 508 and/or one or more trailing edge indications 510 are received at a first time, the prior device state 522 may be associated with a second time prior to the first time. Prior device state 522 may be determined by control circuit 502 at the second time. Prior device state 522 may be determined from undefined state 512, holstered state 514, unholstered state 516, partial holstered state 518, partial unholstered state 520, and/or other device states. In response to one or more leading edge indications 508 and/or one or more trailing edge indications 510, control circuit 502 may determine a state transition from prior device state 522 to device state 524. Further, device state 524 may be determined from holstered state 514, unholstered state 516, partial holstered state 518, partial unholstered state 520, and/or other device states based at least on previous device state 522, one or more leading edge indications 508, and/or one or more trailing edge indications 510. It should be noted that device state 524 may be determined independent of prior device state 522 based at least on one or more leading edge indications 508 and/or one or more trailing edge indications 510.

In various embodiments, undefined state 512 may be associated with an initial state of a simulation device that is reported to a simulation environment based at least on an activation of the simulation device. In particular, and based at least on the one or more leading edge sensors of leading edge 504 and the one or more trailing edge sensors of trailing edge 506, control circuit 502 may be configured to manage a device state (e.g., prior device state 522, device state 524, etc.) for a simulation device independent of a calibration sequence. Additionally, device state 524 may be determined by control circuit 502 on a periodic, aperiodic, triggered, random, and/or other basis and reported to a simulation environment associated with the simulation device. As a result, activation of control circuit 502 (e.g., power on for simulation device, reset of simulation device, other activation associated with the simulation device) may result in an attempted state determination occurring where prior optical indications are absent, unavailable, and/or inappropriate for use. Where prior optical indications are unavailable for use in determining the device state, control circuit 502 may determine a null set of prior optical indications. Attempts to determine a leading edge delta from the null set of prior optical indications and one or more leading edge indications 508 may result in a null leading edge delta (e.g., determining a difference between a valid reading and an invalid reading produces an undefined delta). Similarly, attempts to determine a trailing edge delta from the null set of prior optical indications and one or more trailing edge indications 510 may result in a null trailing edge delta. Further, control circuit 502 may determine, based at least on the null leading edge delta and/or the null trailing edge delta, that the device state is undefined state 512. The undefined state 512 may be otherwise configured to be a standby state, a null state, a start state, and/or other state that indicates to the simulation system that the simulation device was activated and the device state is unknown.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosure is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

Systems, methods, and apparatus are provided herein. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A state management system, the state management system comprising:
a first set of sensors associated with a leading edge of a simulation device, the first set of sensors generating first optical information associated with the leading edge;
a second set of sensors associated with a trailing edge of the simulation device, the second set of sensors generating second optical information associated with the trailing edge; and
a control circuit communicatively associated with the first set of sensors and the second set of sensors, wherein:
the control circuit determines, based at least on the first optical information, a first optical information delta associated with the leading edge;
the control circuit determines, based at least on the second optical information, a second optical information delta associated with the trailing edge;
the control circuit determines, based at least on the first optical information delta and the second optical information delta, a device state of the simulation device; and
the control circuit provides, to a simulation environment associated with the simulation device, one or more indications associated with the device state of the simulation device.

2. The state management system of claim 1, wherein:
the first optical information is initial first optical information captured at a first time and the first set of sensors captures additional first optical information at a second time; and
the second optical information is initial second optical information captured at the first time and the second set of sensors captures additional second optical information at the second time.

3. The state management system of claim 2, wherein:
the first optical information delta comprises a first difference between the initial first optical information and the additional first optical information; and
the second optical information delta comprises a second difference between the initial second optical information and the additional second optical information.

4. The state management system of claim 2, wherein:
the initial first optical information and the additional first optical information comprise one or more indications of total luminance detected by the first set of sensors at the leading edge; and
the initial second optical information and the additional second optical information comprise one or more additional indications of total luminance detected by the second set of sensors at the trailing edge.

5. The state management system of claim 1, wherein:
the control circuit determines a leading edge event based at least on the first optical information delta, the leading edge event indicating whether the first set of sensors has detected a rising leading edge event or a falling leading edge event; and
the control circuit determines a trailing edge event based at least on the second optical information delta, the trailing edge event indicating whether the second set of sensors has detected a rising trailing edge event or a falling trailing edge event.

6. The state management system of claim 5, wherein:
the control circuit determines that the trailing edge event is the falling trailing edge event based at least on the second optical information delta satisfying a falling event threshold; and
the control circuit determines that the simulation device is associated with the device state of holstered based at least on the falling trailing edge event.

7. The state management system of claim 5, wherein:
the control circuit determines that the leading edge event is the rising leading edge event based at least on the first optical information delta satisfying a rising event threshold; and
the control circuit determines that the simulation device is associated with the device state of unholstered based at least on the rising leading edge event.

8. The state management system of claim 5, wherein:
the control circuit determines that the trailing edge event is the rising trailing edge event based at least on the second optical information delta satisfying a rising event threshold; and
the control circuit determines that the simulation device is associated with the device state of being unholstered based at least on the rising trailing edge event.

9. The state management system of claim 5, wherein:
the control circuit determines that the leading edge event is the falling leading edge event based at least on the first optical information delta satisfying a falling event threshold; and
the control circuit determines that the simulation device is associated with the device state of being holstered based at least on the falling leading edge event.

10. The state management system of claim 1, wherein the simulation device is a virtual reality controller and the simulation environment is a virtual reality environment.

11. A simulation device, the simulation device comprising:
a leading edge of the simulation device;
a trailing edge of the simulation device, the trailing edge disposed opposite the leading edge along a first axis extending between a deployment end of the simulation device and a handle end of the simulation device;
a first set of sensors associated with the leading edge, the first set of sensors comprising at least a first optical sensor disposed proximate to a first side surface and a second optical sensor disposed proximate to a second side surface opposite the first side surface;
a second set of sensors associated with the trailing edge, the second set of sensors comprising at least a third optical sensor disposed proximate to the first side surface and a fourth optical sensor disposed proximate to the second side surface; and
a control circuit communicatively associated with the first set of sensors and the second set of sensors, the control circuit configured to determine a device state based at least on one or more rising edge events and one or more falling edge events.

12. The simulation device of claim 11, wherein the first optical sensor and the second optical sensor of the first set of sensors are disposed at a leading edge point along the first axis and are spaced along a second axis, perpendicular to the first axis, that extends through the first side surface and the second side surface.

13. The simulation device of claim 12, wherein the third optical sensor and the fourth optical sensor of the second set of sensors are disposed at a trailing edge point along the first axis and are spaced along a third axis, perpendicular to the first axis and parallel to the second axis, that extends through the first side surface and the second side surface.

14. The simulation device of claim 11, wherein the control circuit monitors first optical information from the first set of sensors and second optical information from the second set of sensors to identify the one or more rising edge events and the one or more falling edge events associated with the leading edge and the trailing edge.

15. The simulation device of claim 11, wherein the control circuit identifies the one or more rising edge events based at least on a minimum positive rate of change in luminance and the one or more falling edge events based at least on a minimum negative rate of change in luminance.

16. A method, the method comprising:
receiving, at a first time, a first optical indication associated with one or more leading edge sensors and a second optical indication associated with one or more trailing edge sensors;
determining, based at least on the first time, a set of prior optical indications associated with at least one of the one or more leading edge sensors or the one or more trailing edge sensors;
determining, based at least on the set of prior optical indications, at least one of a leading edge delta or a trailing edge delta; and
determining, based at least one of the leading edge delta or the trailing edge delta, a device state associated with the first time.

17. The method of claim 16, wherein the device state is determined based at least on one or more of:
the trailing edge delta indicating that the device state is a holstered device state;
the leading edge delta indicating that the device state is an unholstered device state;
the leading edge delta and the trailing edge delta indicating that the device state is a partially holstered device state; or
the leading edge delta and the trailing edge delta indicating that the device state is a partially unholstered device state.

18. The method of claim 17, wherein:
the holstered device state is determined based at least on one or more prior trailing edge indications and the trailing edge delta indicating that a falling trailing edge event has been detected;
the unholstered device state is determined based at least on one or more prior leading edge indications are utilized in combination with the leading edge delta to determine that a rising leading edge event has been detected;
the partially holstered device state is determined based at least on the leading edge delta indicating a leading edge falling event has been detected and the trailing edge delta indicating that the one or more trailing edge sensors are unassociated with a falling edge event threshold; or
the partially unholstered device state is determined based at least on the trailing edge delta indicating a trailing edge rising event has been detected and the leading edge delta is unassociated with a raising edge event threshold.

19. The method of claim 16, wherein the first optical indication is received based on at least one of:
an activation signal causing the first optical indication to be received; or
a period of time elapsing between the first time and a second time associated with the set of prior optical indications.

20. The method of claim 16, wherein:
determining the set of prior optical indications comprises determining that the set of prior optical indications is a null set of prior optical indications;
determining, based at least on the null set of prior optical indications, that at least one of the leading edge delta or the trailing edge delta is a null delta; and
determining, based at least on the null delta, that the device state is an undefined state associated with an activation of a simulation device.
